(19) United States
(12) Patent Application Publication
(10) Pub. No.: US 2016/0192327 A1
(43) Pub. Date: Jun. 30, 2016

(54) METHOD FOR INFORMING MTCH SUSPENSION INFORMATION IN A MBMS WIRELESS COMMUNICATION SYSTEM AND DEVICE THEREFOR

(71) Applicant: LG ELECTRONICS INC., Seoul (KR)

(72) Inventors: Seungjune YI, Seoul (KR); Sangwon KIM, Seoul (KR); Sunyoung LEE, Seoul (KR)

(73) Assignee: LG ELECTRONICS INC., Seoul (KR)

(21) Appl. No.: 14/820,109

(22) Filed: Aug. 6, 2015

Related U.S. Application Data
(60) Provisional application No. 62/097,132, filed on Dec. 29, 2014.

(51) Int. Cl. H04W 72/00; H04W 72/12

(52) U.S. Cl. CPC H04W 72/005; H04W 72/1289

(57) ABSTRACT

The present invention relates to a wireless communication system. More specifically, the present invention relates to a method and a device for informing MTCH suspension information in a MBMS wireless communication system, the method comprising: receiving, from a Base Station (BS), MCH (Multicast Channel) scheduling information indicating which MTCH (Multicast Traffic Channel) transmissions is performed on which subframes; receiving, from the BS, MTCH suspend information including information indicating which MTCH transmissions are suspended or to be suspended; and delivering the received the MTCH suspend information to an upper layer if an indication indicating that a MAC PDU including a MTCH suspend information is valid for the UE is received from the BS.

This application claims the benefit of the U.S. patent application Ser. No. 62/097,132 filed on Dec. 29, 2014, which is hereby incorporated by reference as if fully set forth herein.

### BACKGROUND OF THE INVENTION

1. Field of the Invention

The present invention relates to a wireless communication system and, more particularly, to a method for informing MTCH suspension information in a MBMS wireless communication system and a device therefor.

2. Discussion of the Related Art

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### SUMMARY OF THE INVENTION

The object of the present invention can be achieved by providing a method for a User Equipment (UE) operating in a wireless communication system, the method comprising: receiving, from a Base Station (BS), MCH (Multicast Channel) scheduling information indicating which MTCH (Multicast Traffic Channel) transmissions is performed on which subframes; receiving, from the BS, MTCH suspend information including information indicating which MTCH transmissions are suspended or to be suspended; and delivering the received the MTCH suspend information to an upper layer if an indication indicating that a MAC PDU including a MTCH suspend information is valid for the UE is received from the BS.

In another aspect of the present invention provided herein is an User Equipment in the wireless communication system, the UE comprising: an RF (radio frequency) module; and a processor configured to control the RF module, wherein the processor is configured to receive from a Base Station (BS), MCH (Multicast Channel) scheduling information indicating which MTCH (Multicast Traffic Channel) transmissions is performed on which subframes, to receive, from the BS, MTCH suspend information including information indicating which MTCH transmissions are suspended or to be suspended, and to deliver the received the MTCH suspend information to an upper layer if an indication indicating that a MAC PDU including a MTCH suspend information is valid for the UE is received from the BS.

Preferably, the method further comprises: discarding the received the MTCH suspend information if the indication indicating that a MAC PDU including a MTCH suspend information is valid for the UE is not received from the BS.

Preferably, the MTCH suspend information is received by a MAC control element.

Preferably, wherein the indication is a LCID.

Preferably, wherein the MTCH suspend information includes one or more LCIDs of suspended or to be suspended MTCHs.

Preferably, an order of the one or more LCIDs listed in the MTCH suspend information has same listing order as in the MCH scheduling information.

Preferably, the MCH scheduling information and the MTCH suspend information are transmitted together.

Preferably, the MTCH suspend information is transmitted in each MCH scheduling period used for the MCH scheduling information at an MAC entity applicable for an MCH.

Preferably, the MTCH suspend information is placed immediately after the MCH scheduling information before a first scheduled MTCH.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2A is a block diagram illustrating network structure of an evolved universal mobile telecommunication system (E-UMTS), and FIG. 2B is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4 is a diagram of an example physical channel structure used in an E-UMTS system;

FIG. 5 is a block diagram of a communication apparatus according to an embodiment of the present invention

FIG. 6 is a diagram for MBMS definition;

FIG. 7 is a diagram for an example of MBSFN area;

FIG. 8 is a diagram for E-MBMS Logical Architecture;

FIG. 9 is a diagram for resource-block structure for MBSFN subframes;

FIG. 10 is a diagram for reference-signal structure for PMCH reception;

FIG. 11 is a diagram for an example of scheduling of MBMS services;

FIG. 12 is a diagram for an example of MCCH transmission schedule;

FIGS. 13a to FIGS. 13b are examples for MCH Scheduling Information MAC control element;

FIG. 14 is an example for informing MTCH suspension information in a MBMS wireless communication system according to embodiments of the present invention; and

FIG. 15 is an example for MTCH suspension information MAC control element according to embodiments of the present invention.

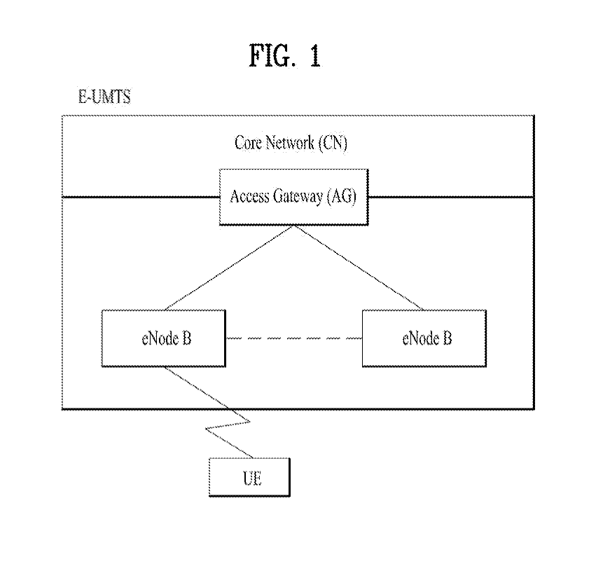

### DETAILED DESCRIPTION OF THE INVENTION

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

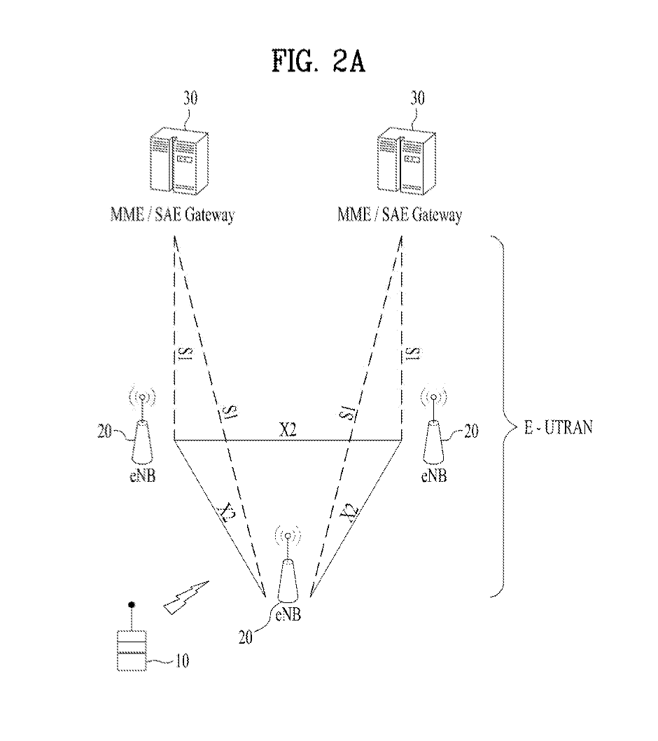

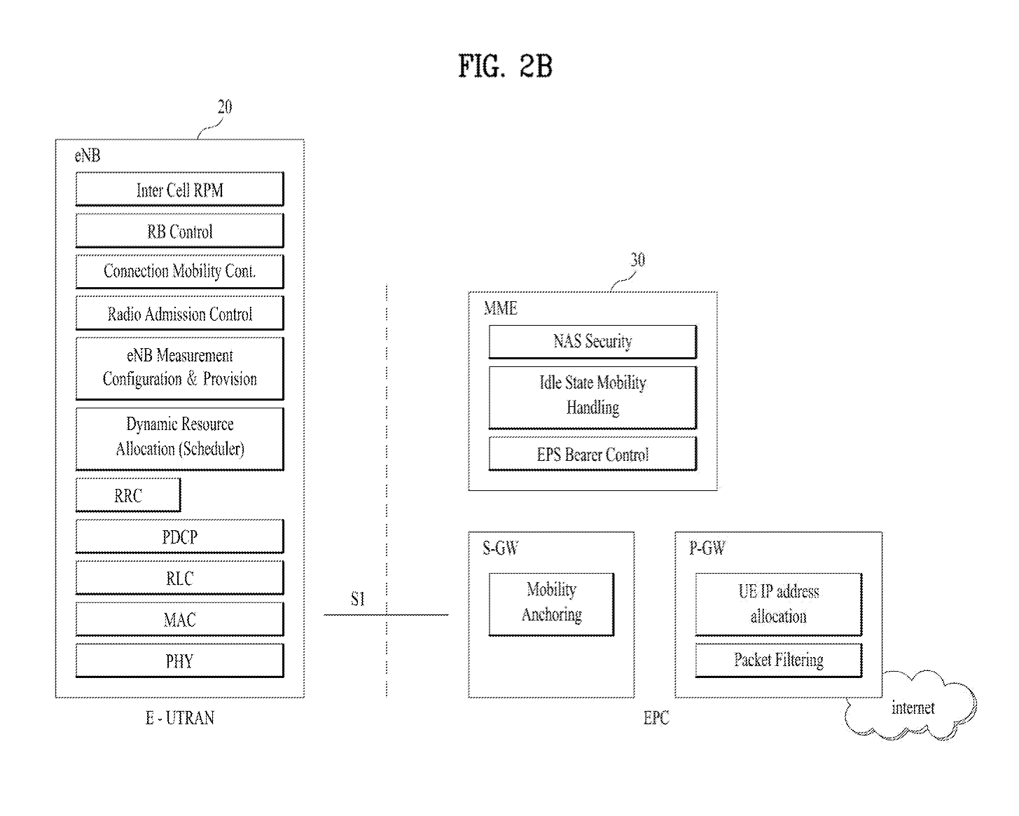

FIG. 2A is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2A, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2B is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

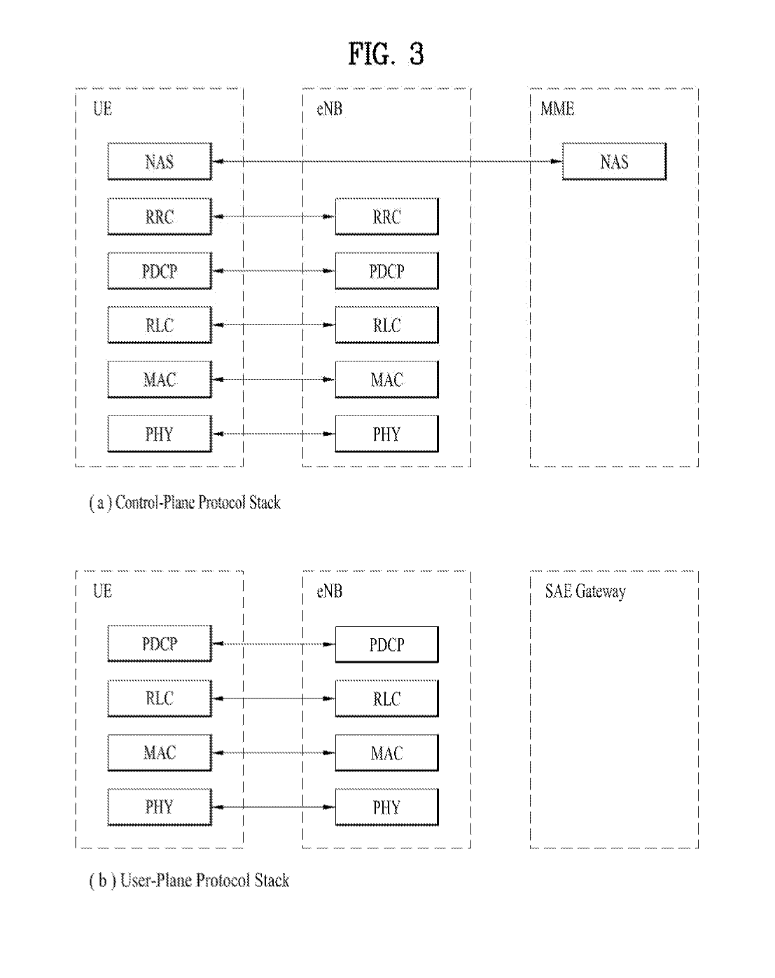

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

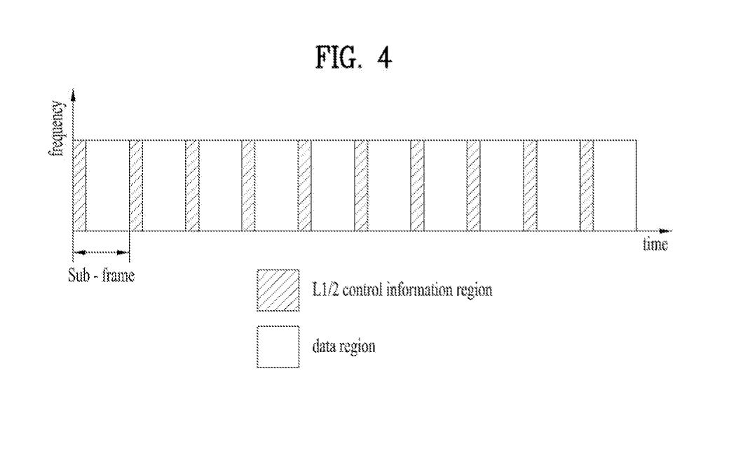

FIG. 4 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. In FIG. 4, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information. A transmission time interval (TTI) which is a unit time for transmitting data is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

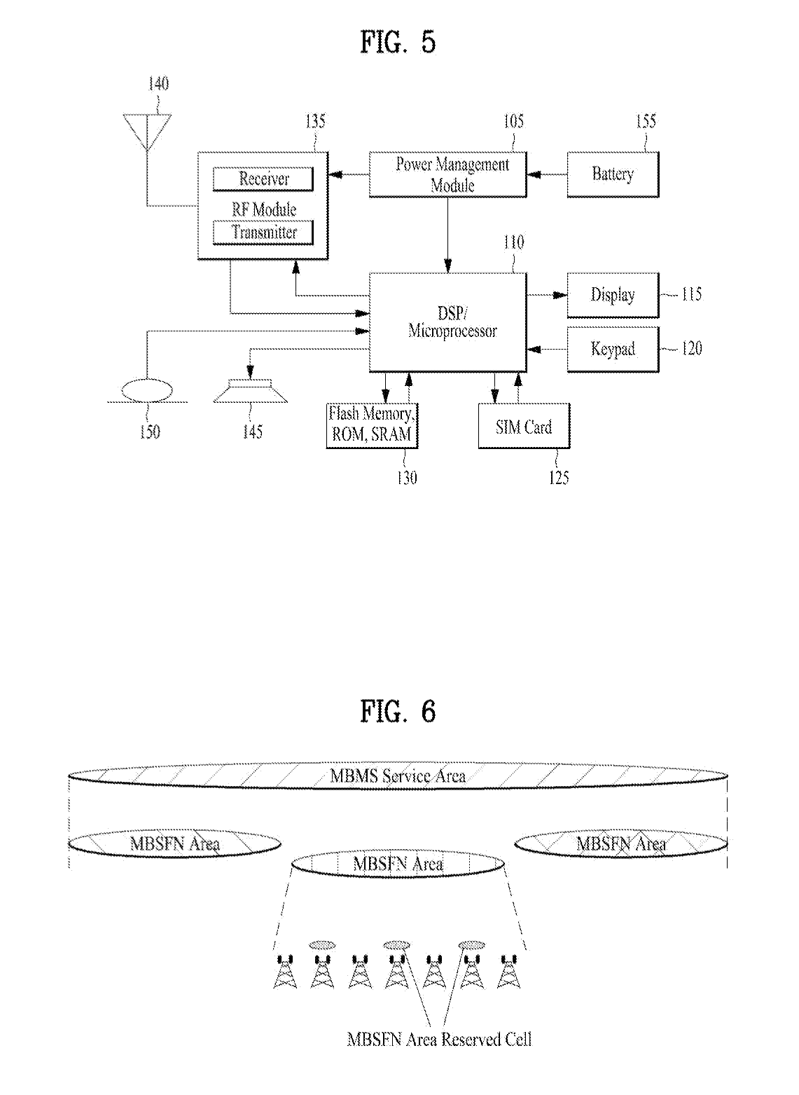

FIG. 5 is a block diagram of a communication apparatus according to an embodiment of the present invention.

The apparatus shown in FIG. 5 can be a user equipment (UE) and/or eNB adapted to perform the above mechanism, but it can be any apparatus for performing the same operation.

As shown in FIG. 5, the apparatus may comprises a DSP/microprocessor (110) and RF module (transmiceiver; 135). The DSP/microprocessor (110) is electrically connected with the transciver (135) and controls it. The apparatus may further include power management module (105), battery (155), display (115), keypad (120), SIM card (125), memory device (130), speaker (145) and input device (150), based on its implementation and designer's choice.

Specifically, FIG. 5 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 5 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

FIG. 6 is a diagram for MBMS definition.

In the past, cellular systems have mostly focused on transmission of data intended for a single user and not on multicast/broadcast services. Broadcast networks, exemplified by the radio and TV broadcasting networks, have on the other hand focused on covering very large areas with the same content and have offered no or limited possibilities for transmission of data intended for a single user. Multimedia Broadcast Multicast Services (MBMS) support multicast/broadcast services in a cellular system, thereby combining the provision of multicast/broadcast and unicast services within a single network.

With MBMS, the same content is transmitted to multiple users located in a specific area, known as the MBMS service area and typically comprising multiple cells. In each cell participating in the transmission, a point-to-multipoint radio resource is configured and all users subscribing to the MBMS service simultaneously receive the same transmitted signal. No tracking of users' movement in the radio-access network is performed and users can receive the content without notifying the network.

When providing multicast/broadcast services for mobile devices, there are several aspects to take into account good coverage and low terminal power consumption.

The coverage, or more accurately the data rate possible to provide, is basically determined by the link quality of the worst-case user, as no user-specific adaptation of transmission parameters can be used in a multicast/broadcast system providing the same information to multiple users. OFDM transmission provides specific benefits for provision of multi-cell multicast/broadcast services. If the transmissions from the different cells are time synchronized, the resulting signal will, from a terminal point of view, appear as a transmission from a single point over a time-dispersive channel. For LTE this kind of transmission is referred to as an MBMS Single-Frequency Network (MBSFN).

MBSFN transmission provides several benefits. Above all, increased received signal strength, especially at the border between cells involved in the MBSFN transmission, as the terminal can utilize the signal energy received from multiple cells. And reduced interference level, once again especially at the border between cells involved in the MBSFN transmission, as the signals received from neighboring cells will not appear as interference but as useful signals. Lastly, additional diversity against fading on the radio channel as the information is received from several, geographically separated locations, typically making the overall aggregated channel appear highly time-dispersive or, equivalently, highly frequency selective.

Altogether, this allows for significant improvements in the multicast/broadcast reception quality, especially at the border between cells involved in the MBSFN transmission, and, as a consequence, significant improvements in the achievable multicast/broadcast data rates.

Providing for power-efficient reception in the terminal in essence implies that the structure of the overall transmission should be such that data for a service-of-interest is provided in short high-data-rate bursts rather than longer low-data-rate bursts. This allows the terminal to occasionally wake up to receive data with long periods of DRX in between. In LTE, this is catered for by time-multiplexing unicast and broadcast transmissions, as well as by the scheduling of different MBMS services.

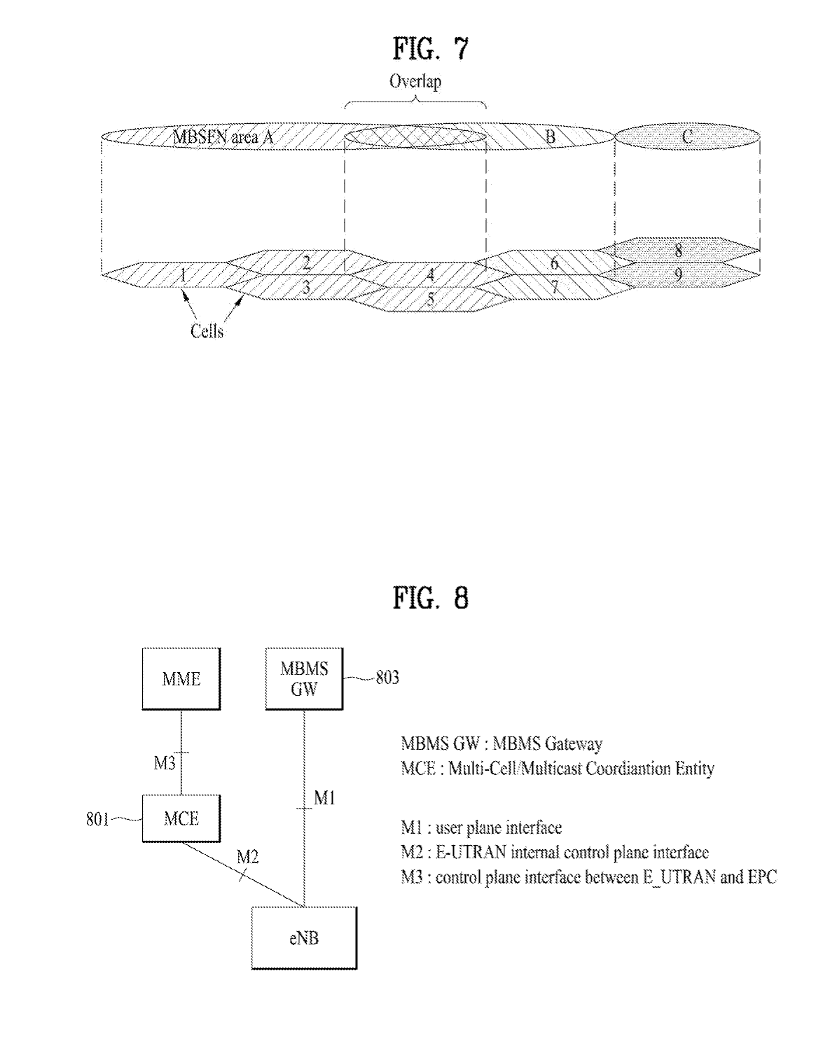

FIG. 7 is a diagram for an example of MBSFN area.

An MBSFN area is a specific area where one or several cells transmit the same content. For example, in FIG. 7, cells 8 and 9 both belong to MBSFN area C. Not only can an MBSFN area consist of multiple cells, a single cell can also be part of multiple, up to eight, MBSFN areas, as shown in FIG. 7, where cells 4 and 5 are part of both MBSFN areas A and B. Note that, from an MBSFN reception point of view, the individual cells are invisible, although the terminal needs to be aware of the different cells for other purposes, such as reading system information and notification indicators, as discussed below. The MBSFN areas are static and do not vary over time.

The usage of MBSFN transmission obviously requires not only time synchronization among the cells participating in an MBSFN area, but also usage of the same set of radio resources in each of the cells for a particular service. This coordination is the responsibility of the Multi-cell/multicast Coordination Entity (MCE), which is a logical node in the radio-access network handling allocation of radio resources and transmission parameters (time-frequency resources and transport format) across the cells in the MBSFN area.

The MBSFN Area consists of a group of cells within an MBSFN Synchronization Area of a network, which are co-ordinated to achieve an MBSFN Transmission. Except for the MBSFN area Reserved Cells, all cells within an MBSFN Area contribute to the MBSFN Transmission and advertise its availability. The UE may only need to consider a subset of the MBSFN areas that are configured, i.e. when it knows which MBSFN area applies for the service(s) it is interested to receive.

MBSFN Synchronization Area is an area of the network where all eNodeBs can be synchronized and perform MBSFN transmissions. MBSFN Synchronization Areas are capable of supporting one or more MBSFN Areas. On a given frequency layer, a eNodeB can only belong to one MBSFN Synchronization Area. MBSFN Synchronization Areas are independent from the definition of MBMS Service Areas. MBSFN Transmission or a transmission in MBSFN mode is a simulcast transmission technique realised by transmission of identical waveforms at the same time from multiple cells. An MBSFN Transmission from multiple cells within the MBSFN Area is seen as a single transmission by a UE.

MBSFN Area Reserved Cell is a cell within a MBSFN Area which does not contribute to the MBSFN Transmission. The cell may be allowed to transmit for other services but at restricted power on the resource allocated for the MBSFN transmission, And Synchronization Period is the synchronization period provides the time reference for the indication of the start time of each synchronization sequence. The time stamp which is provided in each SYNC PDU is a relative value which refers to the start time of the synchronization period. The duration of the synchronization period is configurable.

FIG. 8 is a diagram for E-MBMS Logical Architecture.

Multi-cell/multicast Coordination Entity (MCE) (801) is a logical entity—this does not preclude the possibility that it may be part of another network element—whose functions are: i) the admission control and the allocation of the radio resources used by all eNBs in the MBSFN area for multi-cell MBMS transmissions using MBSFN operation. The MCE decides not to establish the radio bearer(s) of the new MBMS service(s) if the radio resources are not sufficient for the corresponding MBMS service(s) or may pre-empt radio resources from other radio bearer(s) of ongoing MBMS service(s) according to ARP. Besides allocation of the time/frequency radio resources this also includes deciding the further details of the radio configuration e.g. the modulation and coding scheme, ii) counting and acquisition of counting results for MBMS service(s), iii) resumption of MBMS session(s) within MBSFN area(s) based on e.g. the ARP and/or the counting results for the corresponding MBMS service(s), and iv) suspension of MBMS session(s) within MBSFN area(s) based e.g. the ARP and/or on the counting results for the corresponding MBMS service(s).

The MCE is involved in MBMS Session Control Signaling. The MCE does not perform UE—MCE signaling. An eNB is served by a single MCE. The MCE can control multiple eNodeBs, each handling one or more cells.

E-MBMS Gateway (MBMS GW)(803) is a logical entity—this does not preclude the possibility that it may be part of another network element—that is present between the BMSC and eNBs whose principal functions is the sending/broadcasting of MBMS packets to each eNB transmitting the service. The MBMS GW uses IP Multicast as the means of forwarding MBMS user data to the eNB. The MBMS GW performs MBMS Session Control Signaling (Session start/update/stop) towards the E-UTRAN via MME.

“M3” Interface (MCE-MME) is an Application Part is defined for this interface between MME and MCE. This application part allows for MBMS Session Control Signaling on E-RAB level (i.e. does not convey radio configuration data). The procedures comprise e.g. MBMS Session Start and Stop. SCTP is used as signaling transport i.e. Point-to-Point signaling is applied.

“MT” Interface (MCE-eNB)is an Application Part is defined for this interface, which conveys at least radio configuration data for the multi-cell transmission mode eNBs and Session Control Signaling. SCTP is used as signaling transport i.e. Point-to-Point signaling is applied.

“M1” Interface (MBMS GW-NB) is a pure user plane interface. Consequently no Control Plane Application Part is defined for this interface. IP Multicast is used for point-to-multipoint delivery of user packets.

The Broadcast Multicast Service Center (BM-SC), located in the core network, is responsible for authorization and authentication of content providers, charging, and the overall configuration of the data flow through the core network. The MBMS gateway (MBMS-GW) is a logical node handling multicast of IP packets from the BM-SC to all eNodeBs involved in transmission in the MBSFN area. It also handles session control signaling via the MME.

From the BM-SC, the MBMS data is forwarded using IP multicast, a method of sending an IP packet to multiple receiving network nodes in a single transmission, via the MBMS gateway to the cells from which the MBMS transmission is to be carried out. Hence, MBMS is not only efficient from a radio-interface perspective, but it also saves resources in the transport network by not having to send the same packet to multiple nodes individually unless necessary. This can lead to significant savings in the transport network.

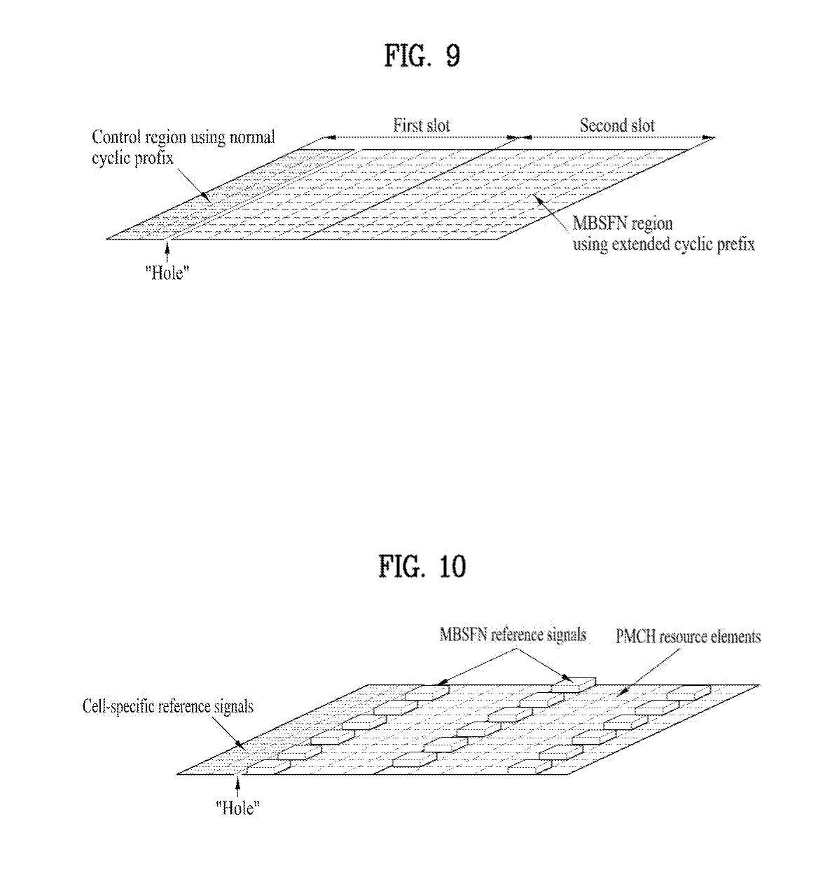

FIG. 9 is a diagram for resource-block structure for MBSFN subframes, and FIG. 10 is a diagram for reference-signal structure for PMCH reception.

The basis for MBSFN transmission is the Multicast Channel (MCH), a transport channel type supporting MBSFN transmission. Multicast Traffic Channel (MTCH) and Multicast Control Channel (MCCH) can be multiplexed and mapped to the MCH.

The MTCH is the logical channel type used to carry MBMS data corresponding to a certain MBMS service. If the number of services to be provided in an MBSFN area is large, multiple MTCHs can be configured. Obviously, as no acknowledgements are transmitted by the terminals, no RLC retransmissions can be used and consequently the RLC unacknowledged mode is used.

The MCCH is the logical channel type used to carry control information necessary for reception of a certain MBMS service, including the subframe allocation and modulation-and-coding scheme for each MCH. There is one MCCH per MBSFN area. Similarly to the MTCH, the RLC uses unacknowledged mode.

One or several MTCHs and, if applicable, one MCCH are multiplexed at the MAC layer to form an MCH transport channel. As already described in Chapter 8, the MAC header contains information about the logical-channel multiplexing, in this specific case the MTCH/MCCH multiplexing, such that the terminal can demultiplex the information upon reception. The MCH is transmitted using MBSFN in one MBSFN area.

The transport-channel processing for MCH is following below:

1. In the case of MBSFN transmission, the same data is to be transmitted with the same transport format using the same physical resource from multiple cells typically belonging to different eNodeBs. Thus, the MCH transport format and resource allocation cannot be dynamically adjusted by the eNodeB. As described above, the transport format is instead determined by the MCE and signaled to the terminals as part of the information sent on the MCCH.

2. As the MCH transmission is simultaneously targeting multiple terminals and therefore no feedback is used, hybrid ARQ is not applicable in the case of MCH transmission.

3. Multi-antenna transmission (transmit diversity and spatial multiplexing) does not apply to MCH transmission.

Furthermore, the PMCH scrambling should be MBSFN-area specific—that is, identical for all cells involved in the MBSFN transmission.

The MCH is mapped to the PMCH physical channel and transmitted in MBSFN subframes, illustrated in FIG. 9. An MBSFN subframe consists of two parts: a control region, used for transmission of regular unicast L1/L2 control signaling; and an MBSFN region, used for transmission of the MCH. Unicast control signaling may be needed in an MBSFN subframe, for example to schedule uplink transmissions in a later subframe, but is also used for MBMS-related signaling.

In the case of MBSFN-based multicast/broadcast transmission, the cyclic prefix should not only cover the main part of the actual channel time dispersion but also the timing difference between the transmissions received from the cells involved in the MBSFN transmission. Therefore, MCH transmissions, which can take place in the MBSFN region only, use an extended cyclic prefix. If a normal cyclic prefix is used for normal subframes, and therefore also in the control region of MBSFN subframes, there will be a small “hole” between the two parts of an MBSFN subframe, as illustrated in FIG. 9. The reason is to keep the start timing of the MBSFN region fixed, irrespective of the cyclic prefix used for the control region.

As already mentioned, the MCH is transmitted by means of MBSFN from the set of cells that are part of the corresponding MBSFN area. Thus, as seen from the terminal point of view, the radio channel that the MCH has propagated over is the aggregation of the channels of each cell within the MBSFN area. For channel estimation for coherent demodulation of the MCH, the terminal can thus not rely on the normal cell-specific reference signals transmitted from each cell. Rather, in order to enable coherent demodulation for MCH, special MBSFN reference symbols are inserted within the MBSFN part of the MBSFN subframe, as illustrated in FIG. 10. These reference symbols are transmitted by means of MBSFN over the set of cells that constitute the MBSFN area—that is, they are transmitted at the same time—frequency position and with the same reference-symbol values from each cell. Channel estimation using these reference symbols will thus correctly reflect the overall aggregated channel corresponding to the MCH transmissions of all cells that are part of the MBSFN area.

MBSFN transmission in combination with specific MBSFN reference signals can be seen as transmission using a specific antenna port, referred to as antenna port 4.

A terminal can assume that all MBSFN transmissions within a given subframe correspond to the same MBSFN area. Hence, a terminal can interpolate over all MBSFN reference symbols within a given MBSFN subframe when estimating the aggregated MBSFN channel. In contrast, MCH transmissions in different subframes may, as already discussed, correspond to different MBSFN areas.

Consequently, a terminal cannot necessarily interpolate the channel estimates across multiple subframes.

As can be seen in FIG. 10, the frequency-domain density of MBSFN reference symbols is higher than the corresponding density of cell-specific reference symbols. This is needed as the aggregated channel of all cells involved in the MBSFN transmission will be equivalent to a highly time-dispersive or, equivalently, highly frequency-selective channel. Consequently, a higher frequency-domain reference-symbol density is needed.

There is only a single MBSFN reference signal in MBSFN subframes. Thus, multi-antenna transmission such as transmit diversity and spatial multiplexing is not supported for MCH transmission.

The main argument for not supporting any standardized transmit diversity scheme for MCH transmission is that the high frequency selectivity of the aggregated MBSFN channel in itself provides substantial (frequency) diversity.

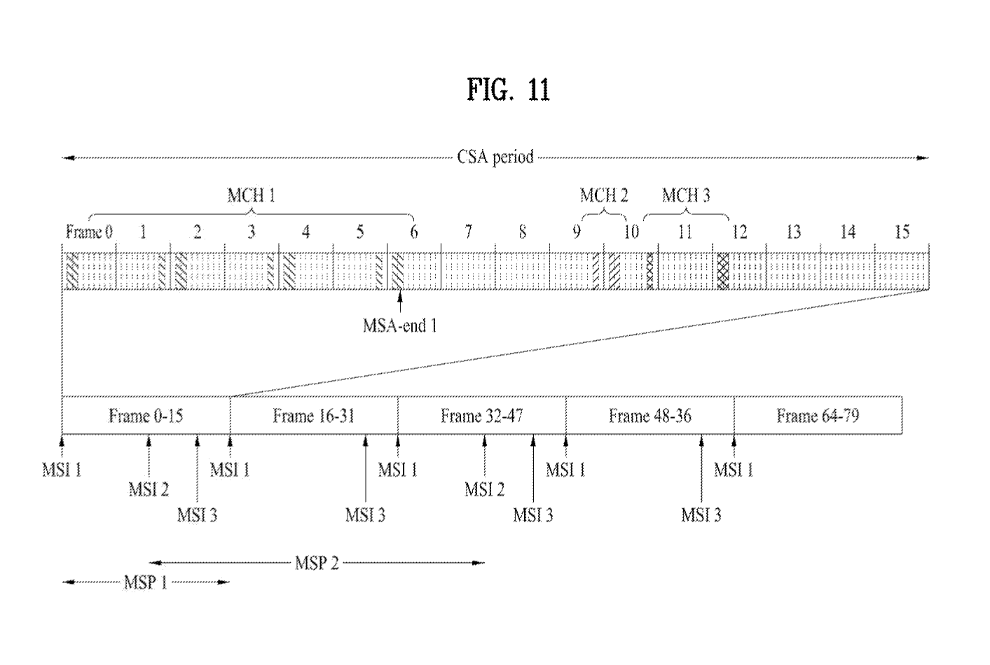

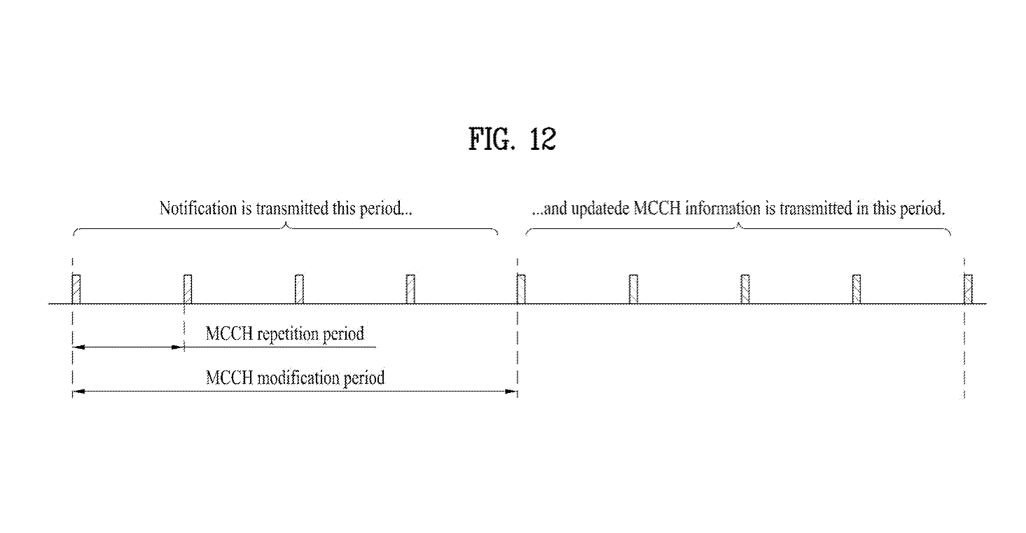

FIG. 11 is a diagram for an example of scheduling of MBMS services, and FIG. 12 is a diagram for an example of MCCH transmission schedule.

Good coverage throughout the MBSFN area is, as already explained, one important aspect of providing broadcast services. Another important aspect, as mentioned in the introduction, is to provide for energy-efficient reception. In essence, for a given service, this translates into transmission of short high-rate bursts in between which the terminal can enter a DRX state to reduce power consumption.

LTE therefore makes extensive use of time-multiplexing of MBMS services and the associated signaling, as well as provides a mechanism to inform the terminal when in time a certain MBMS service is transmitted. Fundamental to the description of this mechanism are the Common Subframe Allocation (CSA) period and the MCH Scheduling Period (MSP).

All MCHs that are part of the same MBSFN area occupy a pattern of MBSFN subframes known as the Common Subframe Allocation (CSA). The CSA is periodic, as illustrated in FIG. 11.

Obviously, the subframes used for transmission of the MCH must be configured as MBSFN subframes, but the opposite does not hold—MBSFN subframes can be configured for other purposes as well, for example to support the backhaul link in the case of relaying.

Furthermore, the allocation of MBSFN subframes for MCH transmission should obviously be identical across the MBSFN area as there otherwise will not be any MBSFN gain. This is the responsibility of the MCE.

Transmission of a specific MCH follows the MCH subframe allocation (MSA). The MSA is periodic and at the beginning of each MCH Scheduling Period (MSP), a MAC control element is used to transmit the MCH Scheduling Information (MSI). The MSI indicates which subframes are used for a certain MTCH in the upcoming scheduling period. Not all possible subframes need to be used; if a smaller number than allocated to an MCH is required by the MTCH(s), the MSI indicates the last MCH subframe to be used for this particular MTCH (MSA end in FIG. 11), while the remaining subframes are not used for MBMS transmission. The different MCHs are transmitted in consecutive order within a CSA period—that is, all subframes used by MCH n in a CSA are transmitted before the subframes used for MCH n+1 in the same CSA period.

The fact that the transport format is signaled as part of the MCCH implies that the MCH transport format may differ between MCHs but must remain constant across subframes used for the same MCH. The only exception is subframes used for the MCCH and MSI, where the MCCH-specific transport format, signaled as part of the system information, is used instead.

In the example in FIG. 11, the scheduling period for the first MCH is 16 frames, corresponding to one CSA period, and the scheduling information for this MCH is therefore transmitted once every 16 frames. The scheduling period for the second MCH, on the other hand, is 32 frames, corresponding to two CSA periods, and the scheduling information is transmitted once every 32 frames. The MCH scheduling periods can range from 80 ms to 10.24 s.

To summarize, for each MBSFN area, the MCCH provides information about the CSA pattern, the CSA period, and, for each MCH in the MBSFN area, the transport format and the scheduling period. This information is necessary for the terminal to properly receive the different MCHs.

However, the MCCH is a logical channel and itself mapped to the MCH, which would result in a chicken-and-egg problem—the information necessary for receiving the MCH is transmitted on the MCH. Hence, in TTIs when the MCCH (or MSI) is multiplexed into the MCH, the MCCH-specific transport format is used for the MCH. The MCCH-specific transport format is provided as part of the system information. The system information also provides information about the scheduling and modifications periods of the MCCH (but not about CSA period, CSA pattern, and MSP, as those quantities are obtained from the MCCH itself). Reception of a specific MBMS service can thus be described by the following steps:

1. Receive SIB 13 to obtain knowledge on how to receive the MCCH for this particular MBSFN area.

2. Receive the MCCH to obtain knowledge about the CSA period, CSA pattern, and MSP for the service of interest.

3. Receive the MSI at the beginning of each MSP. This provides the terminal with information on which subframes the service of interest can be found in.

After the second step above, the terminal has acquired the CSA period, CSA pattern, and MSP. These parameters typically remain fixed for a relatively long time. The terminal therefore only needs to receive the MSI and the subframes in which the MTCH carrying the service of interest are located, as described in the third bullet above. This greatly helps to reduce the power consumption in the terminal as it can sleep in most of the subframes.

Occasionally there may be a need to update the information provided on the MCCH, for example when starting a new service. Requiring the terminal to repeatedly receive the MCCH comes at a cost in terms of terminal power consumption. Therefore, a fixed schedule for MCCH transmission is used in combination with a change-notification mechanism, as described below.

The MCCH information is transmitted repeatedly with a fixed repetition period and changes to the MCCH information can only occur at specific time instants. When (parts of) the MCCH information is changed, which can only be done at the beginning of a new modification period, as shown in FIG. 12, the network notifies the terminals about the upcoming MCCH information change in the preceding MCCH modification period. The notification mechanism uses the PDCCH for this purpose. An eight-bit bitmap, where each bit represents a certain MBSFN area, is transmitted on the PDCCH in an MBSFN subframe using DCI format 1C and a reserved identifier, the M-RNTI. The notification bitmap is only transmitted when there are any changes in the services provided (in release 10, notification is also used to indicate a counting request in an MBSFN area) and follows the modification period described above.

The purpose of the concept of notification indicators and modification periods is to maximize the amount of time the terminal may sleep to save battery power. In the absence of any changes to the MCCH information, a terminal currently not receiving MBMS may enter DRX and only wake up when the notification indicator is transmitted. As a PDCCH in an MBSFN subframe spans at most two OFDM symbols, the duration during which the terminal needs to wake up to check for notifications is very short, translating to a high degree of power saving. Repeatedly transmitting the MCCH is useful to support mobility; a terminal entering a new area or a terminal missing the first transmission does not have to wait until the start of a new modification period to receive the MCCH information.

In the prior art it is not possible for the RAN to inform the UE of the suspension/interruption of an MBMS bearer by the eNB in such a way that service disruption is prevented/minimized for a Group Call that is able to be transferred to unicast. Especially for Public Safety Group Calls, this will lead to unacceptable service quality. Therefore two mechanisms are proposed in the prior art to quickly inform the UE whether there has been an impact to service from the RAN such that it can acquire a unicast bearer to continue the service.

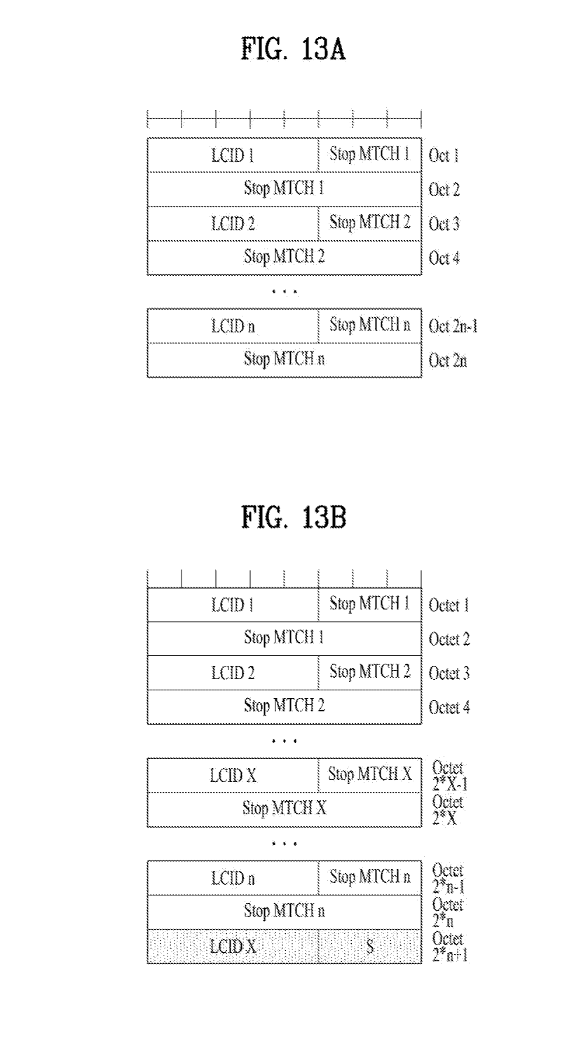

FIGS. 13a to FIGS. 13b are examples for MCH Scheduling Information MAC control element.

In case of FIG. 13a (the 1st mechanism), if the MCH Scheduling Information MAC control element indicates that MTCH transmission is to be suspended, the UE shall pass this information to higher layers, but shall continue to follow MCH reception rules (e.g. in case further MTCH transmission is scheduled). The MCH Scheduling Information MAC Control Element illustrated in FIG. 13a is identified by a MAC PDU subheader with LCID. This control element has a variable size. A “LCID” field indicates the Logical Channel ID of the MTCH. The length of the field is 5 bits. And “Stop MTCH” field indicates the ordinal number of the subframe within the MCH scheduling period, counting only the subframes allocated to the MCH, where the corresponding MTCH stops. Value 0 corresponds to the first subframe. The length of the field is 11 bits. The special Stop MTCH value 2047 indicates that the corresponding MTCH is not scheduled. The special Stop MTCH value 2046 indicates that the corresponding MTCH is to be suspended by the eNB. The value range 2043 to 2045 is reserved.

In case the MAC control element contains an instance of “Stop MTCH” containing value 2046 and an instance of “Stop MTCH” containing a value between 0 and 2045 both for the same MTCH, it is recommended that the Stop MTCH instance containing the value 2046 is located after the other Stop MTCH instance.

However, in the 1st mechanism regarding FIG. 13a, the legacy UE regards the value “2046” as “reserved”, and ignore the whole control elements containing the reserved values. Consequently, the legacy UE would not receive whole MTCHs transmitted in that MSCH Scheduling Period.

In case of FIG. 13b (the 2nd mechanism), the “Stop MTCH” field indicates the ordinal number of the subframe within the MCH scheduling period, counting only the subframes allocated to the MCH, where the corresponding MTCH stops. The special Stop MTCH value 2047 indicates that the corresponding MTCH is not scheduled. The value range 2043 to 2046 is reserved.

Additionally, a new “S” field is added in the MCH Scheduling Information MAC Control Element.

The “S” field indicates that the service is to be suspended. This field presents only when a LCID is repeated at the end of MSI. There may be one or multiple session suspending indications (each includes a repeated LCID and a S field) present at the end of MSI. The value 000 of S indicates that the session of LCID will be suspended. All other values are reserved in this release of specification.

However, in the 2nd mechanism regarding FIG. 13b, the legacy UE does not know the meaning of “S”, and would consider that the MAC PDU is not valid, and may discard the received MAC PDU.

Both two mechanisms cause backward compatibility problem, so a new mechanism should be introduced.

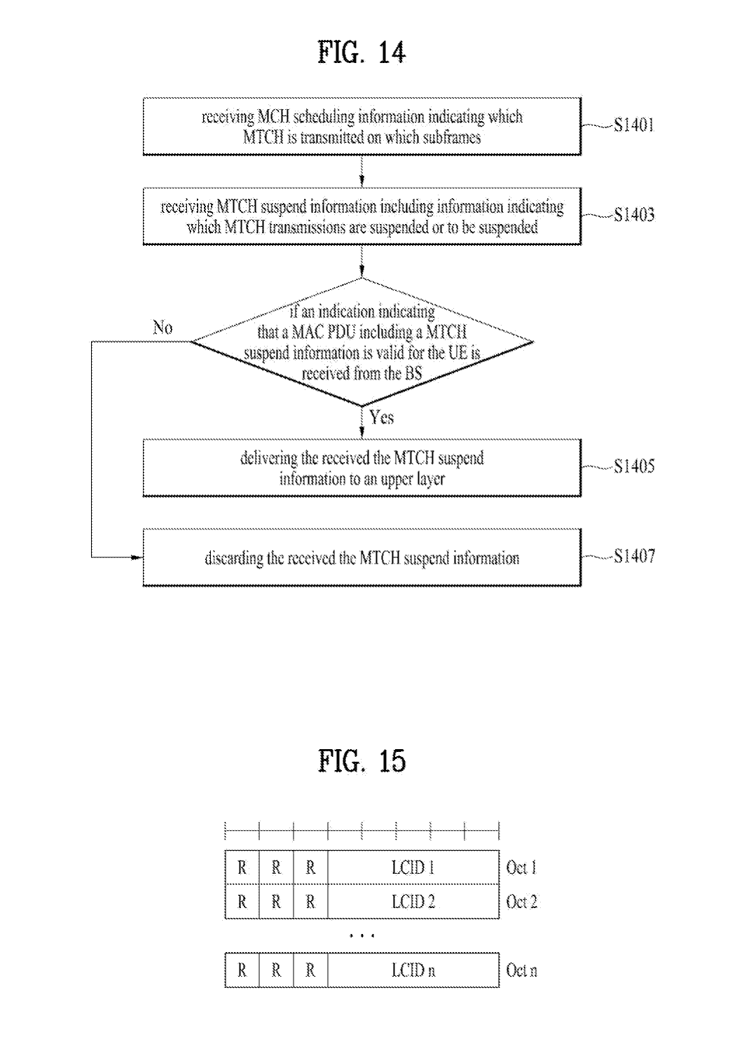

FIG. 14 is an example for informing MTCH suspension information in a MBMS wireless communication system according to embodiments of the present invention.

Rather than introducing a special value in “Stop MTCH”, the idea is to introduce a new “MTCH Suspend Information MAC CE (MTSI MAC CE)” for the MCH MAC PDU. The MTSI MAC CE indicates that the MTCHs are suspended or to be suspended due to network congestion. When the UE receives the MTSI MAC CE, the UE shall pass this information to RRC to request the unicast transmission of the MBMS service transmitted by the MTCH.

The user equipment (UE) receives MCH (Multicast Channel) scheduling information from the base station (BS) (S1401). The MCH scheduling information indicates which MTCH transmission is transmitted on which subframes. And also the UE receives MTCH suspend information including information from the BS (S1403). The MTCH suspend information including information indicates which MTCH transmissions are suspended or to be suspended.

Preferably, the MTCH suspend information is received by a MAC control element.

Preferably, the MTCH suspend information includes one or more LCIDs of suspended MTCHs.

Preferably, an order of the one or more LCIDs listed in the MTCH suspend information has same listing order as in the MCH scheduling information.

Preferably, the MCH scheduling information and the MTCH suspend information are transmitted together, or the MTCH suspend information is transmitted in each MCH scheduling period used for the MCH scheduling information at an MAC entity applicable for an MCH.

Preferably, the MTCH suspend information is placed immediately after the MCH scheduling information before a first scheduled MTCH.

If an indication indicating that a MAC PDU including a MTCH suspend information is valid for the UE is received from the BS, the UE delivers the received the MTCH suspend information to an upper layer (S1405).

Otherwise, if the indication indicating that a MAC PDU including a MTCH suspend information is valid for the UE is not received from the BS, the UE discards the received the MTCH suspend information (S1407).

Preferably, the indication is a LCID.

FIG. 15 is an example for MTCH suspension information MAC control element according to embodiments of the present invention.

Regarding FIG. 15, a MTSI MAC CE according to embodiments of the present invention has following characteristics.

Above all, the MTSI MAC CE is allocated to one of a currently reserved LCID value (e.g. LCID=11101). The length of MTSI MAC CE is variable, so F/L field is included in the MAC subheader.

The MTSI MAC CE can be transmitted together with MSI MAC CE (MCH Scheduling Information MAC control element), or MTSI MAC CE is transmitted in each MCH Scheduling Period. It is possible to transmit MTSI MAC CE multiple times in each MCH Scheduling Period, in which case a new period, e.g. MTCH suspend notification period, may be introduced.

The MTSI MAC CE is placed immediately after MSI MAC CE before the first scheduled MTCH. The MTSI MAC CE is composed of one or more LCIDs of suspended MTCHs. The order of LCIDs listed in the MTSI MAC CE has the same listing order as in the MSI MAC CE, and for octet alignment, three R bits are prepended to each LCID field.

The MTSI MAC CE may indicate suspend or resume for each MTCH. One of R bit could be used to indicate suspension/resumption of one MTCH.

In conclusion, an MTCH Suspend Information MAC control element is included immediately after the MCH Scheduling Information MAC control element to indicate which MTCH transmissions are suspended or to be suspended. The MAC entity shall assume that the first scheduled MTCH starts immediately after the MCCH or the MTCH Suspend Information.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein

1. A method for a User Equipment (UE) operating in a wireless communication system, the method comprising:
receiving, from a Base Station (BS), MCH (Multicast Channel) scheduling information indicating which MTCH (Multicast Traffic Channel) transmissions is performed on which subframes;
receiving, from the BS, MTCH suspend information including information indicating which MTCH transmissions are suspended or to be suspended; and
delivering the received the MTCH suspend information to an upper layer if an indication indicating that a MAC PDU including a MTCH suspend information is valid for the UE is received from the BS.

2. The method according to claim 1, further comprising:
discarding the received the MTCH suspend information if the indication indicating that a MAC PDU including a MTCH suspend information is valid for the UE is not received from the BS.

3. The method according to claim 1, wherein the MTCH suspend information is received by a MAC control element.

4. The method according to claim 1, wherein the indication is a LCID.

5. The method according to claim 1, wherein the MTCH suspend information includes one or more LCIDs of suspended or to be suspended MTCHs.

6. The method according to claim 5, wherein an order of the one or more LCIDs listed in the MTCH suspend information has same listing order as in the MCH scheduling information.

7. The method according to claim 1, wherein the MCH scheduling information and the MTCH suspend information are transmitted together.

8. The method according to claim 1, wherein the MTCH suspend information is transmitted in each MCH scheduling period used for the MCH scheduling information at an MAC entity applicable for an MCH.

9. The method according to claim 1, wherein the MTCH suspend information is placed immediately after the MCH scheduling information before a first scheduled MTCH.

10. The method according to claim 1, wherein MTCH suspend information further indicates which MTCH transmissions are resumed or to be resumed.

11. A communication apparatus adapted to carry out the method of claim 1.

12. A communication apparatus adapted to carry out the method of claim 10.
